(19) United States
(12) Patent Application Publication
(10) Pub. No.: US 2025/0065873 A1
(43) Pub. Date: Feb. 27, 2025

(54) METHOD, CONTROL DEVICE AND MOTOR VEHICLE FOR CONTROLLING AN AT LEAST PARTIALLY AUTONOMOUS EGO MOTOR VEHICLE

(71) Applicant: Volkswagen Aktiengesellschaft, Wolfsburg (DE)

(72) Inventors: Stefan Detering, Braunschweig (DE); Alex Tarasow, Braunschweig (DE)

(21) Appl. No.: 18/812,045

(22) Filed: Aug. 22, 2024

(30) Foreign Application Priority Data
Aug. 22, 2023 (DE) 10 2023 208 031.1

(51) Int. Cl. B60W 30/165; B60W 10/04; B60W 10/18; B60W 10/20; B60W 30/09; B60W 30/095; B60W 30/18; B60W 60/00

(52) U.S. Cl. CPC B60W 30/165; B60W 10/04; B60W 10/18; B60W 10/20; B60W 30/09; B60W 30/0953; B60W 30/0956; B60W 30/18163; B60W 60/0015; B60W 2520/14; B60W 2554/4043; B60W 2554/4045; B60W 2554/80; B60W 2555/20; B60W 2555/60

(57) ABSTRACT

A method controls an at least partially autonomous ego motor vehicle having a positive driving behavior in the event of turning off or a lane change of a relevant road user. The method includes determining a current shortest distance between the ego motor vehicle and the relevant road user, determining a safety measure which contains a collision probability, determining an ideal speed of the ego motor vehicle at which a predefined safety measure is attainable, and determining a speed-based adjustment value for acceleration and/or deceleration of the ego motor vehicle based on the ideal speed. The method further includes determining a distance-based adjustment value for acceleration and/or deceleration of the ego motor vehicle based on a hazard factor kept available by the storage unit, selecting between the speed-based adjustment value and the distance-based adjustment value, and controlling deceleration or acceleration of the ego motor vehicle.

### CROSS-REFERENCE TO RELATED APPLICATION

This application claims the priority, under 35 U.S.C. § 119, of German Patent Application DE 10 2023 208 031.1, filed Aug. 22, 2023; the prior application is herewith incorporated by reference in its entirety.

### FIELD AND BACKGROUND OF THE INVENTION

The invention relates to a method for controlling an at least partially autonomous ego motor vehicle. The ego motor vehicle has a control device with a computing device, and a sensor device or communication device. The method includes at least the following steps:
by means of the sensor device or the communication device, detecting a relevant road user;
by means of the computing device, determining a probability value in respect of the relevant road user leaving an anticipated travel route of the ego motor vehicle; and
by means of the computing device, comparing the probability value with a defined limit value.

The prior art discloses methods for controlling a vehicle speed which control a desired distance during convoy travel of a vehicle for a relevant road user. It is also known to determine a probability value in order to establish when a relevant road user turns off and the convoy travel control is terminated and free speed control is thus possible.

Chinese patent CN115257734A discloses for example a method for adaptive speed control for a motor vehicle, wherein a status of the brake lights of a vehicle ahead is determined in a first step. The relative position and speed of the vehicle vis-à-vis the vehicle ahead are determined in a subsequent step. Taking the determined values into account, in the event of predefined threshold values being exceeded, the vehicle is decelerated to a safe distance.

Japanese patent JP2022157639A discloses for example a method for a driving assistance system of a motorcycle, wherein a necessary vehicle distance with respect to the vehicle ahead is determined on the basis of the present road conditions. Upon detection of a curve, the vehicle distance of the motorcycle is adaptable by means of regulation of the vehicle speed.

International patent disclosure WO 2022157433A1 discloses for example a method for controlling a cruise control system of a motor vehicle, wherein the motor vehicle follows a second motor vehicle through cornering. The present cornering and the maximum speed of the motor vehicle within the curve are determined in a first step. In a subsequent step, an acceleration, depending on the vehicle distance, a minimum safety distance and a maximum speed, to a target acceleration value is implementable on the basis of the time at which the second motor vehicle enters the curve.

German patent DE 102019129512 discloses for example a control module configured to set the speed of a vehicle based on the turning off probability pertaining to a vehicle ahead.

### SUMMARY OF THE INVENTION

Against the background of previously known methods, control devices and motor vehicles, the invention is based on the object of solving the following problem with the simplest and most cost-effective means possible.

The intention is to provide a method, a control device and a motor vehicle which allow predictive speed control of the motor vehicle during a maneuver (such as, for example, turning off, a lane change or the like) of a road user traveling ahead or alongside. Consequently, it is also possible to react to unexpected situations, for example where a road user ahead and turning off stops, without an undesired severe and unnecessary reduction of speed being carried out. For example, in this way a particularly humanlike driving behavior is attainable and the motor vehicle is able to be accelerated again early on.

According to the independent method claim, the object is achieved by virtue of the fact that, if the probability value exceeds the limit value, the method furthermore comprises the following steps for controlling the speed of the ego motor vehicle:
by means of the computing device, determining a current shortest distance between the ego motor vehicle and the relevant road user;
by means of the computing device, determining a safety measure which comprises at least one collision probability;
by means of the computing device, determining an ideal speed of the ego motor vehicle at which a predefined safety measure is attainable;
by means of the computing device, determining a speed-based adjustment value for acceleration and/or deceleration of the ego motor vehicle on the basis of the ideal speed determined in step f.;
by means of the computing device, determining a distance-based adjustment value for acceleration and/or deceleration of the ego motor vehicle on the basis of a hazard factor kept available by means of the storage unit;
by means of the computing device, selecting between the speed-based adjustment value and the distance-based adjustment value; and
by means of the control device, controlling deceleration or acceleration of the ego motor vehicle on the basis of the adjustment value selected in step i.

According to the independent control device claim, the object is achieved by virtue of the fact that the control device is configured for carrying out such a method.

According to the independent motor vehicle claim, the object is achieved by virtue of the fact that the ego motor vehicle has such a control device which is configured at least for controlling the drive unit.

Advantageous developments of the invention are characterized in the dependent claims.

In accordance with a first embodiment of the invention, a method for controlling an at least partially autonomous ego motor vehicle is proposed, wherein the ego motor vehicle has a control device having a computing device, and a sensor device or communication device. The method comprises at least the following steps:
by means of the sensor device or the communication device, detecting a relevant road user;
by means of the computing device, determining a probability value in respect of the relevant road user leaving an anticipated travel route of the ego motor vehicle; and
by means of the computing device, comparing the probability value with a defined limit value.

The method is primarily characterized in that, if the probability value exceeds the limit value, the method furthermore comprises the following steps for controlling the speed of the ego motor vehicle:
by means of the computing device, determining a current shortest distance between the ego motor vehicle and the relevant road user;
by means of the computing device, determining a safety measure which comprises at least one collision probability;
by means of the computing device, determining an ideal speed of the ego motor vehicle at which a predefined safety measure is attainable;
by means of the computing device, determining a speed-based adjustment value for acceleration and/or deceleration of the ego motor vehicle on the basis of the ideal speed determined in step f.;
by means of the computing device, determining a distance-based adjustment value for acceleration and/or deceleration of the ego motor vehicle on the basis of a hazard factor kept available by means of the storage unit;
by means of the computing device, selecting between the speed-based adjustment value and the distance-based adjustment value; and
by means of the control device, controlling deceleration or acceleration of the ego motor vehicle on the basis of the adjustment value selected in step i.

The relevant road user is preferably a road user traveling ahead. Alternatively, the relevant road user is for example a road user traveling alongside.

Preferably, the predefined safety measure which is attainable by means of the ideal speed determined in step f. corresponds to the safety measure determined in step e. Preferably, the ideal speed is thus determined in step f. on the basis of the safety measure determined in step e. in such a way that the safety measure is attained with the ideal speed.

In one advantageous embodiment of the method, the probability value determined in step b. is a probability value in respect of turning off and/or a lane change of the relevant road user.

In one advantageous embodiment of the method, step b. contains the following sub-steps:
b.1 by means of a computing device, determining a maneuvering intention of the relevant road user for carrying out a steering maneuver, for example turning off and/or a lane change;
b.2 by means of the computing device, determining a following intention of the ego motor vehicle for following the steering maneuver of the relevant road user; and
b.3 by means of the computing device, determining the probability value on the basis of the maneuvering intention determined in step b.1 and the following intention determined in step b.2.

In one advantageous embodiment of the method, the maneuvering intention is determined as a maneuvering probability and the following intention is determined as a following probability.

In one advantageous embodiment of the method, the probability value is determined in step b. on the basis of at least one of the following factors:
a turning off signal, preferably a light signal or a hand signal, of the relevant road user and/or of the ego motor vehicle;
a transverse acceleration of the relevant road user and/or of the ego motor vehicle;
a longitudinal acceleration of the relevant road user and/or of the ego motor vehicle;
navigation data of the relevant road user and/or of the ego motor vehicle;
a communication message of the relevant road user; and
detecting a turning off possibility or a lane change possibility, preferably on the basis of a traffic sign, a map and/or a camera recording.

In one advantageous embodiment of the method, the collision probability is determined on the basis of the following sub-steps:
e.1.1 determining a turning off point of the relevant road user;
e.1.2 determining at least one potential travel progression of the relevant road user;
e.1.3 determining at least one potential travel progression of the ego motor vehicle; and
e.1.4 determining a potential temporal progression of the shortest distance based on the turning off point determined in step e.1.1, the potential travel progression of the relevant road user determined in step e.1.2 and the potential travel progression of the ego motor vehicle determined in step e.1.3.

In one advantageous embodiment of the method, in a step e.2 an action margin of the ego motor vehicle for a worst-case scenario is determined, and in step e. the safety measure is determined on the basis of the action margin and the collision probability.

In one advantageous embodiment of the method, the action margin in step e.2 contains a remaining distance if the ego motor vehicle and the relevant road user come completely to a standstill in a worst-case scenario.

In one advantageous embodiment of the method, the action margin is determined for straight ahead travel of the relevant road user and the remaining distance is a longitudinal distance.

In one advantageous embodiment of the method, the action margin is determined on the basis of at least one of the following parameters for the relevant road user and/or the ego motor vehicle:
a driver type;
the type of vehicle;
further road users;
road conditions;
weather conditions; and
current kinematic data (distance, speed, acceleration, yaw angle, yaw rate, etc.) of the ego vehicle and of the relevant vehicle.

In one advantageous embodiment of the method, the action margin contains a safety factor so that the action margin is definable by means of the safety factor between a minimum distance for which a crash is actually preventable in a worst-case scenario and a maximum distance.

In one advantageous embodiment of the method, in step e. the safety measure, preferably the action margin and/or the collision probability, is determined on the basis of map data and/or swarm data, preferably by means of an artificial intelligence.

In one advantageous embodiment of the method, the hazard factor is determined in accordance with step h. based on the collision probability and the action margin, preferably by means of a set of characteristic curves.

Furthermore, a control device is proposed which has at least the following components:
a computing device;
a storage unit; and
a sensor device and/or a communication device, wherein the control device is configured for carrying out a method according to an embodiment in accordance with the description above.

Furthermore, an ego motor vehicle is proposed which has at least the following components:
a drive unit for providing a drive torque;
a braking device for providing a braking torque;
at least one propulsion wheel which is torque-transmittingly coupled to the drive unit and the braking device and by means of which a propulsion of the motor vehicle is providable on the basis of the drive torque and respectively the braking torque; and
a control device according to an embodiment in accordance with the description above, which is configured at least for controlling the drive unit in accordance with a method according to an embodiment in accordance with the description above.

Other features which are considered as characteristic for the invention are set forth in the appended claims.

Although the invention is illustrated and described herein as embodied in a method for controlling an at least partially autonomous ego motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a flowchart of a method for controlling the speed of an ego motor vehicle according to the invention;

FIG. 2 is a decision diagram from a section of the method according to FIG. 1;

FIG. 3 is a schematic illustration of a turning off procedure of a road user traveling ahead;

FIG. 4 is a further schematic illustration of the turning off procedure of the relevant road user;

FIG. 5 is schematic illustration of a lane change of a relevant road user; and

FIG. 6 shows a motor vehicle comprising a control device for carrying out the method according to FIG. 1.

### DETAILED DESCRIPTION OF THE INVENTION

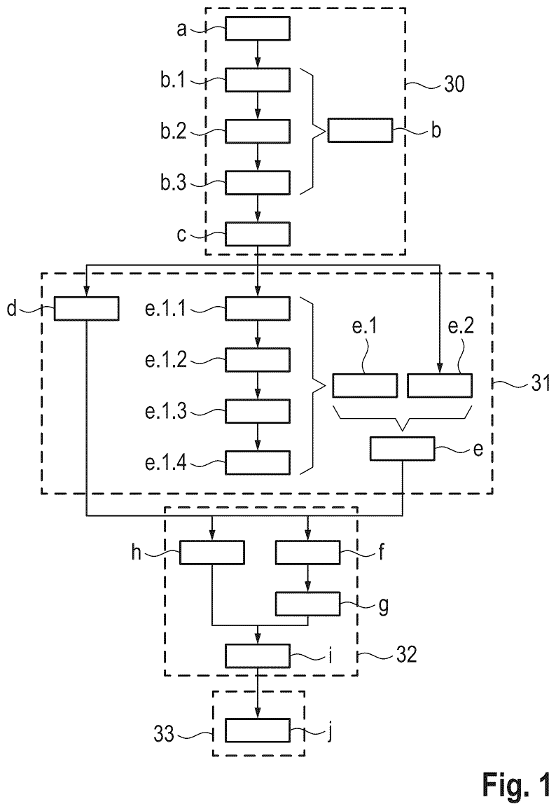

Referring now to the figures of the drawings in detail and first, particularly to FIG. 1 thereof, there is shown a flowchart of a method for controlling a speed of an ego motor vehicle 100. The method serves for controlling a vehicle speed of an ego motor vehicle 100 or a distance 22 between an ego motor vehicle 100 and a relevant road user 20 when the relevant road user 20 is anticipated to leave a travel route 21 of the ego motor vehicle 100. Leaving the travel route 21 in this way occurs for example when the relevant road user 20 turns off or changes lane.

The relevant road user 20 is preferably a motor vehicle 100. However, the method can also be used in the case of a bicycle, pedestrian or some other relevant road user 20.

In a first phase 30 of the method, a corresponding situation is recognized as turning off or a lane change of the relevant road user 20 and the method is thus initiated. For this purpose, the relevant road user 20 is detected in a step a.

By way of example, the motor vehicle 100 is following the relevant road user 20 in convoy travel. For this purpose, by means of a control device of the ego motor vehicle 100, a closed-loop control (not explained in more specific detail here) of the convoy travel is preferably carried out in which the ego motor vehicle 100 follows the relevant road user 20 at a safe distance 22. Such closed-loop controls are known to a person skilled in the art by the term adaptive cruise control (ACC), for example. This closed-loop control of convoy travel takes place for example during straight ahead travel of the ego motor vehicle 100 and of the relevant road user 20 and/or during turning off or a lane change of the relevant road user 20 that is followed by the ego motor vehicle 100.

If the ego motor vehicle 100 is following the relevant road user 20 in convoy travel, the relevant road user 20 is already detected in a step a. Preferably, the motor vehicle 100 has a sensor device 14, for example a front camera, a LiDAR sensor and/or a radar sensor, by means of which the relevant road user 20 is detectable. Alternatively or additionally, the ego motor vehicle 100 comprises a communication device, by means of which data regarding a relevant road user 20 are receivable. Preferably, the communication device is configured for vehicle-to-vehicle communication, such that data or messages from the relevant road user 20 are receivable by means of the communication device of the ego motor vehicle 100.

In a case in which the ego motor vehicle 100 is not following the relevant road user 20 in controlled convoy travel, it is nevertheless possible to carry out the method. By way of example, the relevant road user 20 is so far away from the ego motor vehicle 100 that controlled convoy travel is not carried out. However, turning off by the relevant road user 20 is suspected, for example, which involves the relevant road user 20 undergoing particularly great deceleration or stopping for a long time on a travel route 21 of the ego motor vehicle 100. By way of example, there is a high probability that the relevant road user 20 is going around a particularly tight curve 26, a flashing indicator for a lane change is set but this lane is still occupied by further road users 20, and the relevant road user 20 wants to turn off left through oncoming traffic, or to turn off right with cyclists or pedestrians passing by. In such a case, the relevant road user 20 is nevertheless detectable by means of the sensor device 14 and/or the communication device in step a. and the method is able to be carried out.

Step b. involves determining, by means of the computing device 11, a probability value in respect of the relevant road user 20 leaving an anticipated travel route 21 of the ego motor vehicle 100. By way of example, the relevant road user 20 turns off or changes lane while the ego motor vehicle 100 continues to travel straight ahead.

For this purpose, preferably, in a sub-step b.1, a maneuvering intention of the relevant road user 20 for carrying out a steering maneuver, preferably turning off and/or a lane change, is determined by means of a computing device 11. Preferably, the maneuvering intention is a maneuvering probability, that is to say a probability with which the relevant road user 20 carries out a corresponding steering maneuver for turning off or changing lane.

By way of example, the maneuvering intention or the maneuvering probability is determined on the basis of a turning off signal, preferably a light signal or a hand signal, of the relevant road user 20; a transverse acceleration of the relevant road user 20; a longitudinal acceleration of the relevant road user 20; a communication message of the relevant road user 20 to the ego motor vehicle 100, which informs the ego motor vehicle 100 about the imminent steering maneuver; and/or detecting a turning off possibility or a lane change possibility, preferably on the basis of a traffic sign, a map and/or a camera recording.

With further preference, what maneuver is intended to be carried out is furthermore determined on the basis of the factors. By way of example, if a flashing indicator of the relevant road user 20 is set, i.e. there is a turning off signal, before a road junction or an intersection, there is a high maneuvering probability for turning off. By contrast, if the flashing indicator is set on the open road, the probability of turning off is low and the maneuvering probability for turning off acquires a low value, for example a value only slightly increased relative to normal straight ahead travel. This is so as to be prepared for any stopping or moving to the roadside, for example.

Preferably, the maneuvering intention is already determined before the beginning of a transverse movement of the relevant road user 20.

In a sub-step b.2, a following intention of the ego motor vehicle 100 for following the steering maneuver of the relevant road user 20 is determined by means of the computing device 11. Preferably, the following intention is a following probability of the ego motor vehicle 100, i.e. a probability with which the ego motor vehicle 100 follows the steering maneuver of the relevant road user 20.

The following intention or following probability is determined for example on the basis of a turning off signal, preferably a light signal, of the ego motor vehicle 100; a steering angle of the ego motor vehicle 100; a longitudinal acceleration or gas pedal position of the ego motor vehicle 100; detection of a turning off possibility or lane change possibility, preferably on the basis of a traffic sign, a map and/or a camera recording and/or the data, preferably of a planned travel route 21, of a navigation system of the ego motor vehicle 100.

Sub-steps b.1 and b.2 thus lead to a following probability. The probability value determined in step b. is for example the reciprocal of the following probability and is determined by means of the computing device 11 in a sub-step b.3, for example.

Here the anticipated travel route 21 of the ego motor vehicle 100 should not be understood to mean the travel route 21 in the sense of an overall route set in the navigation system, but rather a lane occupied by the ego motor vehicle 100 in a route section ahead. Preferably, the length of the corresponding route section is a maximum of one kilometer, with further preference a maximum of 500 meters.

By way of example, driving in convoy may have been defined in advance, such that the probability value is very low and convoy travel is terminated or interrupted only if necessary for traffic reasons. A low probability value is likewise present for example if the relevant road user 20 carries out a lane change in order to drive around a truck convoy on the interstate highway. A high probability value is present for example if the relevant road user 20 turns off into a driveway of a house or the route of the ego motor vehicle 100 provides straight ahead travel and the relevant road user 20 signals turning off.

In a step c., the probability value is compared with a defined limit value by means of the computing device 11. If the probability value exceeds the limit value, the steps explained below for controlling the vehicle speed are carried out. In this case, the method steps are designed to engender as pleasant a driving sensation as possible for the occupant of the ego motor vehicle 100 in the event of the relevant road user 20 leaving the anticipated travel route 21 of the ego motor vehicle 100. By way of example, firstly, deceleration in a timely fashion is desirable in order to bring about sufficient safety or a strong feeling of safety for the occupant when the relevant road user 20 slows down during turning off or lane changing. Moreover, acceleration or reacceleration early on is possible.

For this purpose, firstly, the intermediate values used for speed control while the road user 20 ahead is leaving the travel route 21 of the ego motor vehicle 100 is calculated in a second phase 31.

If it has thus been established that the probability value exceeds a limit value, in a step d., a current shortest distance 22 between the ego motor vehicle 100 and the relevant road user 20 is determined by means of the computing device 11. The shortest distance 22 is the distance 22 along a direct connection between ego motor vehicle 100 and relevant road user 20. By way of example, the shortest distance 22 thus extends from a corner of the ego motor vehicle 100 to a corner of the relevant road user 20, instead of—as in previous methods—from a central point of the front edge of the ego motor vehicle 100 to the relevant road user 20. Furthermore, the shortest distance 22 is preferably defined in such a way that it also concomitantly encompasses the distance 22 in the transverse direction 28, i.e. not just in the longitudinal direction 27, pertaining to the ego motor vehicle 100.

In a step e., a safety measure which comprises at least one collision probability is determined by means of the computing device 11. Preferably, the safety measure furthermore comprises an action margin.

Determining the collision probability is represented here by step e.1, and determining the action margin by step e.2. By way of example, the safety measure exclusively consists of the collision probability. In one exemplary embodiment, the action margin and the collision probability are computed to form a common safety measure that is used for calculating the ideal speed in step f. Alternatively, the safety measure comprises the collision probability and the action margin as separate values, which for example are used separately for calculating the ideal speed in step f. or are used for further steps.

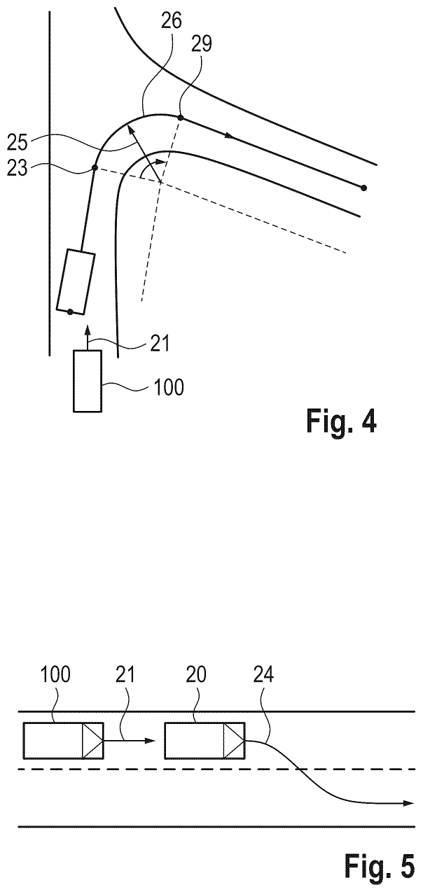

In order to determine the collision probability, firstly a turning off point 23 of the relevant road user 20 is determined in a sub-step e.1.1. The turning off point 23 is for example the point at which the relevant road user 20 transitions from straight ahead travel to cornering (cf. FIG. 4).

In a further sub-step e.1.2, at least one potential travel progression 24 of the relevant road user 20 is determined. Preferably, the potential travel progression 24 comprises a location-time progression, i.e. indicates at what place the relevant road user 20 will prospectively be situated at what point in time. By way of example, the travel progression 24 is determined on the basis of one driver profile, preferably a plurality of driver profiles. By way of example, three driver profiles are kept available, one for a sporty turning off behavior, one for an average turning off behavior and one for a slow turning off behavior. Moreover, by way of example, ambient conditions such as weather, radius 25 of the curve 26 and other road users are taken into account.

In sub-step e.1.3, at least one potential travel progression of the ego motor vehicle 100 is determined. By way of example, the travel progression is a location-time progression of straight ahead travel, i.e. indicates the travel route with a time component. This travel progression, too, thus indicates for example at what place the ego motor vehicle 100 will prospectively be situated at a specific point in time. By way of example, the travel progression of the ego motor vehicle 100 is determined on the basis of one driver profile, preferably a plurality of driver profiles. By way of example, three driver profiles are kept available, one for a sporty turning off behavior, one for an average turning off behavior and one for a slow turning off behavior. Preferably, the travel progression of the ego motor vehicle 100 is determined on the basis of an individual driver profile of the respective driver of the ego motor vehicle 100. Moreover, by way of example, ambient conditions such as weather, radius 25 of the curve 26 and other road users are taken into account.

Sub-step e.1.4 involves determining a potentially shortest distance 22 based on the turning off point 23 determined in step e.1.1, the potential travel progression 24 of the relevant road user 20 determined in step e.1.2 and the potential travel progression of the ego motor vehicle 100 determined in step e.1.3. By way of example, the shortest distance 22 is determined for each driver profile or driver profile combination of driver profiles for the relevant road user 20 and the ego motor vehicle 100 in accordance with sub-steps e.1.2 and e.1.3.

The collision probability is then determined from the potentially shortest distance 22. For example, by way of a set of characteristic curves, each shortest distance 22 is assigned a collision probability or the collision probability is determinable from the potentially shortest distance 22 by way of an analytical equation. For example, the entire collision probability is ascertained by way of averaging over the individual driver profiles, for example according to the theorem of total probability. The collision probability thus offers a basis for assessment in respect of the fact that in the case of an expected travel progression of the ego motor vehicle 100 and of the relevant road user 20, a critical proximity between the two will occur and, consequently, the ideal speed of the ego motor vehicle 100, in comparison with the current vehicle speed, should be reduced or may even be increased in order to avoid such a critical proximity.

The action margin in accordance with step e.2 is determined for a worst-case scenario, i.e. not the expected travel progression in accordance with step e.1. The action margin in accordance with step e.2 is based on a remaining distance between the ego motor vehicle 100 and the relevant road user 20 if the ego motor vehicle 100 and the relevant road user 20 come completely to a standstill in a worst-case scenario. In other words, for example, if the relevant road user 20 abruptly decelerates before having completely left the travel route 21 of the ego motor vehicle 100, for example because an unexpected obstacle is blocking the turning off route, the ego motor vehicle 100 is also decelerated accordingly. On account of the reaction time or braking distances of different lengths, for example on account of the previous different speeds, the installed brakes or the vehicle weight, the distance 22 between the ego motor vehicle 100 and the relevant road user 20 is shortened in the process. The shortest remaining distance which is usually reached once both have come to a standstill is thus determined for such a worst-case scenario. The remaining distance is determined here for a case in which the relevant road user 20 does not leave the travel route 21 of the ego motor vehicle 100, i.e. does not carry out cornering. Preferably, the remaining distance is determined as the longitudinal distance between the ego motor vehicle 100 and the relevant road user 20.

By way of example, the action margin is a distance margin. In order to ascertain the distance margin, first the remaining distance is determined. Afterward, by way of example, a percentage evaluation of the remaining distance is effected in such a way that the remaining distances which fall below a defined minimum distance are assigned a percentage value of the distance margin of 0% [zero percent]. In this case, the remaining distances which exceed a defined maximum distance are assigned a percentage value of the distance margin of 100% [one hundred percent]. Remaining distances which are between the minimum distance and the maximum distance are assigned a value interpolated linearly, for example. In this way, it is possible to represent a safety factor so that the necessary action margin is definable by means of the safety factor between a minimum distance for which a crash is actually preventable in the worst-case scenario and a maximum distance.

In a third phase 32, from the intermediate variables which were determined in the second phase 31, adjustment values are determined in order to control the speed of the ego motor vehicle 100.

Step f. involves determining, by means of the computing device 11, an ideal speed of the ego motor vehicle 100 based on the safety measure determined in step e. By way of example, the ideal speed of the ego motor vehicle 100 is defined in such a way that the critical proximity between the ego motor vehicle 100 and the relevant road user 20 does not occur. The calculation of the ideal speed preferably takes into account the time or path distance required for adapting the speed from the current vehicle speed to the ideal speed. The ideal speed is determinable for example on the basis of a driver profile, for example on the basis of the driver profile which is used for the determination of the safety measure.

A step g. involves determining, by means of the computing device 11, a speed-based adjustment value for acceleration and/or deceleration of the ego motor vehicle 100 on the basis of the safety measure determined in step f. The speed-based adjustment value is configured for example to control a drive unit 15 and/or a break device so that the ego motor vehicle 100 is able to be accelerated or decelerated based on the speed-based adjustment value. By way of example, the storage unit 13 keeps available a maximum acceleration value and/or a maximum deceleration value used to limit the speed-based adjustment value. In this way, a high level of user comfort is able to be ensured and/or specific standards are able to be complied with.

A step h. involves determining, by means of the computing device 11, a distance-based adjustment value for acceleration and/or deceleration of the ego motor vehicle 100 on the basis of a hazard factor kept available by means of the storage unit 13. The hazard factor is for example a risk factor or a harmlessness factor. Preferably, the hazard factor as risk factor assumes a value of between 0 [zero] and −1 [minus one] and thus leads to deceleration of the ego motor vehicle 100. Preferably, the hazard factor as harmlessness factor assumes a value of between 0 [zero] and 1 [plus one] and thus leads to acceleration of the ego motor vehicle 100. Preferably, the hazard factor is kept available in one set of characteristic curves in the storage unit 13 or kept available in a plurality of sets of characteristic curves, for example separately as risk factor and as harmlessness factor. By way of example, the set of characteristic curves or the sets of characteristic curves map(s) the hazard factor as a function of the action margin which is determined in step e.2. Alternatively or additionally, the hazard factor is based for example on the critical proximity determined in step e.1 or the collision probability between the ego motor vehicle 100 and the relevant road user 20. Alternatively or additionally, the hazard factor is determined analytically by means of a mathematical model or by means of an AI.

A step i. involves selecting between the speed-based adjustment value and the distance-based adjustment value by means of the computing device 11. Preferably, the adjustment value which leads to minimum acceleration and/or maximum deceleration of the ego motor vehicle 100 is chosen here. In other words, a minimum value selection takes place here.

In a last phase 33, a step j. involves controlling, by means of the control device 10, deceleration or acceleration of the ego motor vehicle 100 on the basis of the adjustment value selected in step i. Therefore, for example, a braking torque is provided by means of a braking device, for example disk brakes or drum brakes or an electric drive machine, or a drive torque is provided by means of the drive unit 15.

By way of example, there is firstly a speed reduction early on in order to comply with the necessary action margin, followed by reacceleration early on if it is certain that the necessary action margin is complied with, for example because the relevant road user 20 has moved completely from the travel route 21 of the ego motor vehicle 100, even if, particularly in the longitudinal direction 27, it is not yet at a large distance 22 from the ego motor vehicle 100.

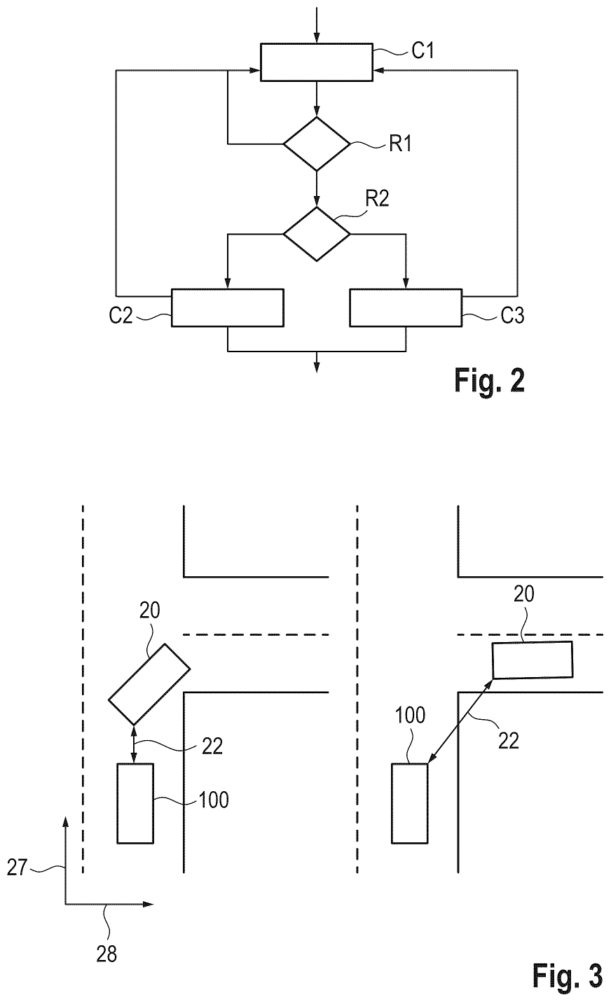

FIG. 2 shows an exemplary decision diagram from a section of the method according to FIG. 1. In this case, in a control block C1, following control of convoy travel takes place, for example, in which the ego motor vehicle 100 follows a relevant road user 20 for example at a defined shortest distance 22.

In order to check whether steps d. to j. of the method according to FIG. 1 are intended to be carried out, the condition R1 is checked as to whether the maneuvering probability determined in step h., for example, exceeds a predetermined maneuvering limit value. If the maneuvering probability is lower than the maneuvering limit value, a steering maneuver of the relevant road user 20 is improbable and the convoy travel or following control is continued.

If the maneuvering probability exceeds the maneuvering limit value, the condition R2 is checked as to whether the probability value determined in step b. in accordance with FIG. 1 exceeds a limit value. If the probability value remains below the limit value, there is a high probability that the ego motor vehicle 100 is following the relevant road user 20. By way of example, in such a case, the ego motor vehicle 100, following the relevant road user 20, thus turns off or follows the relevant road user 20 during a lane change. Accordingly, the motor vehicle 100 remains in the following control or switches to a separate following control for the respective steering maneuver, represented here by the control block C3.

If the probability value is greater than the limit value, there is a high probability that the relevant road user 20 is leaving the travel route 21 of the ego motor vehicle 100. The probability of convoy travel being continued is thus low. Consequently, the control device 10 switches to the control method described with reference to FIG. 1 and carries out steps d. to j., represented here by the control block C2.

FIG. 3 shows a schematic illustration of a turning off procedure of a relevant road user 20. This illustrates the shortest distance 22 between the relevant road user 20 and the ego motor vehicle 100, toward which the control in accordance with the method according to FIG. 1 is oriented. Instead of being oriented toward the center of the vehicle rear of the relevant road user 20 and using the distance 22 in the own travel direction or longitudinal direction 27 for the control, the shortest distance 22 is determined in step d., as already explained.

Therefore, if the relevant road user 20 turns off, the distance 22 in the longitudinal direction 27 is not ideal for the control. The reason for this is that, during turning off, the relevant road user 20 makes a movement in the longitudinal direction 27 and a movement in the transverse direction 28. Consequently, the movement in the longitudinal direction 27 decreases until the relevant road user 20 ultimately only moves in the transverse direction 28 when turning off through 90°. Consequently, from the viewpoint of the ego motor vehicle 100, the relevant road user 20 appears to be at a standstill in the longitudinal direction 27, which leads to an unnecessarily great reduction of speed in the case of known control systems.

The proposed method in accordance with FIG. 1 counteracts that by being geared toward the shortest distance 22 extending between a part of the relevant road user 20 that is situated closest to the ego motor vehicle 100 and a part of the ego motor vehicle 100 that is situated closest to the relevant road user 20. Consequently, in accordance with the illustration on the right, for example, a distance 22 from vehicle corner to vehicle corner constitutes the shortest distance 22. Furthermore, for example, as is likewise discernible in the illustration on the right, the shortest distance 22 extends both in the transverse direction 28 and in the longitudinal direction 27.

Consequently, after the turning off by the relevant road user 20, the shortest distance 22 increases again more quickly and the travel of the ego motor vehicle 100 is delayed to a lesser extent.

FIG. 4 shows a further schematic illustration of a turning off procedure of a relevant road user 20. In order to determine a critical proximity in step e.1 of the method according to FIG. 1, the travel progression 24 of the relevant road user 20 is determined, as explained. By way of example, this involves determining a turning off point 23, from where travel through the curve 26 by the relevant road user 20 begins, and a curve end point 29, at which the travel of the relevant road user 20 transitions to straight ahead travel again and has completely left the travel route 21 of the ego motor vehicle 100.

By way of example, swarm data and/or map data, for example from a digital navigation map, are usable for the determination of the travel progression 24 of the relevant road user 20. By way of example, such data comprise a radius 25 with which the relevant road user 20 is anticipated to go through the curve 26, and a speed at which for example a specific driver profile goes through a curve with such a radius 25.

Swarm data are recorded for example by a plurality of vehicles, for example of a vehicle fleet, when traveling along a route section. By way of example, in this case, camera recordings are used and roadway markings and roadway boundaries or other traffic signs contained in said recordings are automatically recognized and registered. The swarm data thus comprise for example recorded camera recordings and/or information about objects determined on the basis of said recordings. Furthermore, swarm data comprise for example speed profiles along a stretch or further vehicle properties. The swarm data are kept available or stored for example at a central server, i.e. for example a cloud server or backend. By way of example, the swarm data are retrievable from the server by means of the control device 10 of the ego motor vehicle 100. This can be done in line with requirements for example based on a respective current position and/or a set navigation route of the motor vehicle 100.

Alternatively or additionally, an artificial intelligence is usable, for example, in order to determine the following travel progression 24 of the relevant road user 20 from the movement thereof.

FIG. 5 shows a schematic illustration of a lane change of a relevant road user 20. As already explained, the method in accordance with FIG. 1 is also usable for a lane change of the relevant road user 20. Such a lane change is illustrated here by way of example. In this case, the method affords the advantage that, for example, the acceleration of the ego motor vehicle 100 can be begun before the relevant road user 20 has turned off completely.

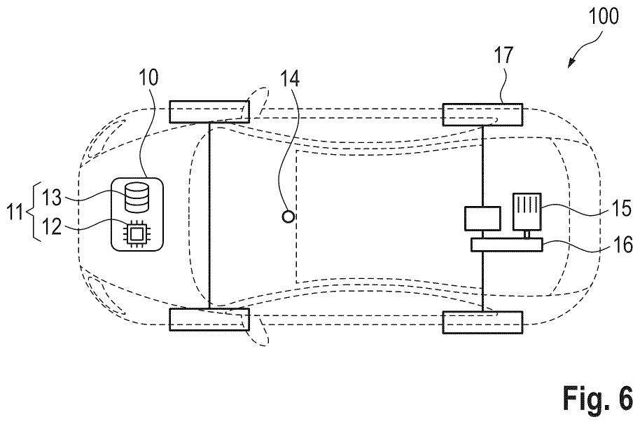

FIG. 6 shows a motor vehicle 100 containing a control device 10 for carrying out the method according to FIG. 1. The control device 10 contains a computing device 11 having a storage unit 13 and a processor 12. The motor vehicle 100 furthermore has a drive unit 15 for providing a drive torque. The drive unit 15 is torque-transmittingly connected to at least one propulsion wheel 17, two propulsion wheels 17 in accordance with the illustration, by means of a transmission 16, for example. By means of the propulsion wheels 17, the torque is convertible into propulsion of the motor vehicle 100.

At least the drive unit 15 of the motor vehicle 100 is controllable by means of the control device 10 in order to control the speed of the motor vehicle 100. In addition, for example, further components of the motor vehicle 100 are controllable by means of the control device 10; preferably, a braking device and/or a steering system are/is controllable by means of the control device 10. The motor vehicle 100 is at least a partially autonomous motor vehicle 100, for example a fully autonomous motor vehicle 100.

Furthermore, the motor vehicle 100 contains a sensor device 14 containing for example a camera, a LiDAR sensor and/or a radar sensor. Preferably, the sensor device 14 is furthermore designed to detect the distance 22 to a relevant road user 20.

The following is a summary list of reference numerals and the corresponding structure used in the above description of the invention:
100 Ego motor vehicle
10 Control device
11 Computing device
12 Processor
13 Storage unit
14 Sensor device
15 Drive unit
16 Transmission
17 Propulsion wheel
20 Relevant road user
21 Travel route
22 Shortest distance
23 Turning off point
24 Travel progression
25 Radius
26 Curve
27 Longitudinal direction
28 Transverse direction
29 Curve end point
30 First phase
31 Second phase
32 Third phase
33 Last phase

1. A method for controlling an at least partially autonomous ego motor vehicle, wherein the ego motor vehicle has a control device with a computing device, and a sensor device or communication device, the method comprises at least the following steps of:
a. detecting, by means of the sensor device or the communication device, a relevant road user;
b. determining, by the computing device, a probability value in respect of the relevant road user leaving an anticipated travel route of the ego motor vehicle;
c. comparing, by the computing device, the probability value with a defined limit value;
if the probability value exceeds the limit value, the method furthermore comprises the following steps for controlling a speed of the ego motor vehicle:
d. determining, by the computing device, a current shortest distance between the ego motor vehicle and the relevant road user;
e. determining, by the computing device, a safety measure which contains at least one collision probability;
f. determining, by the computing device, an ideal speed of the ego motor vehicle at which a predefined safety measure is attainable;
g. determining, by the computing device, a speed-based adjustment value for acceleration and/or deceleration of the ego motor vehicle on a basis of the ideal speed determined in the step f;
h. determining, by the computing device, a distance-based adjustment value for acceleration and/or deceleration of the ego motor vehicle on a basis of a hazard factor kept available by a storage unit;
i. selecting, by the computing device, between the speed-based adjustment value and the distance-based adjustment value; and
j. controlling, by the control device, deceleration or acceleration of the ego motor vehicle on a basis of the speed-based adjustment value or the distance-based adjustment value selected in the step i.

2. The method according to claim 1, wherein the probability value determined in the step b is a probability value in respect of turning off and/or a lane change of the relevant road user.

3. The method according to claim 1, wherein the step b comprises at least the following sub-steps:
b.1 determining, by the computing device, a maneuvering intention of the relevant road user for carrying out a steering maneuver;
b.2 determining, by the computing device, a following intention of the ego motor vehicle for following the steering maneuver of the relevant road user; and
b.3 determining, by the computing device, the probability value on a basis of the maneuvering intention determined in the step b.1 and the following intention determined in the step b.2.

4. The method according to claim 3, wherein the maneuvering intention is determined as a maneuvering probability and the following intention is determined as a following probability.

5. The method according to claim 3, wherein the probability value is determined in the step b on a basis of at least one of the following factors:
a turning off signal of the relevant road user and/or of the ego motor vehicle;
a transverse acceleration of the relevant road user and/or of the ego motor vehicle;
a longitudinal acceleration of the relevant road user and/or of the ego motor vehicle;
navigation data of the relevant road user and/or of the ego motor vehicle;
a communication message of the relevant road user; and
detecting a turning off possibility or a lane change possibility.

6. The method according to claim 1, wherein the at least one collision probability is determined on a basis of the following sub-steps:
e.1.1 determining a turning off point of the relevant road user;
e.1.2 determining at least one potential travel progression of the relevant road user;
e.1.3 determining at least one potential travel progression of the ego motor vehicle; and
e.1.4 determining a potential temporal progression of the shortest distance based on the turning off point determined in the step e.1.1, the potential travel progression of the relevant road user determined in the step e.1.2 and the potential travel progression of the ego motor vehicle determined in the step e.1.3.

7. The method according to claim 1, wherein:
in a step e.2 an action margin of the ego motor vehicle for a worst-case scenario is determined; and
in the step e. the safety measure is determined on a basis of the action margin and the at least one collision probability.

8. The method according to claim 7, wherein the action margin in the step e.2 includes a remaining distance if the ego motor vehicle and the relevant road user come completely to a standstill in the worst-case scenario.

9. The method according to claim 8, wherein the action margin is determined for straight ahead travel of the relevant road user and the remaining distance is a longitudinal distance.

10. The method according to claim 7, wherein the action margin is determined on a basis of at least one of the following parameters for the relevant road user and/or the ego motor vehicle:
a driver type;
a type of vehicle;
further road users;
road conditions;
weather conditions; and
current kinematic data including distance, speed, acceleration, yaw angle, and yaw rate of the ego vehicle and of the relevant vehicle.

11. The method according to claim 7, wherein the action margin includes a safety factor so that the action margin is definable by means of the safety factor between a minimum distance for which a crash is actually preventable in the worst-case scenario and a maximum distance.

12. The method according to claim 7, wherein in the step e the safety measure is determined on a basis of map data and/or swarm data.

13. The method according to claim 7, wherein the hazard factor is determined in accordance with the step h based on the collision probability or a critical proximity and the action margin.

14. The method according to claim 3, wherein the steering maneuver is turning off maneuver and/or a lane change maneuver.

15. The method according to claim 5, wherein:
the turning off signal is a light signal or a hand signal; and
detecting the turning off possibility or a lane change possibility on a basis of a traffic sign, a map and/or a camera recording.

16. The method according to claim 12, wherein the safety measure is the action margin and/or the at least one collision probability and is determined on the basis of the map data and/or the swarm data by means of an artificial intelligence.

17. The method according to claim 7, wherein the hazard factor is determined in accordance with the step h based on the at least one collision probability or a critical proximity and the action margin by means of a set of characteristic curves.

18. A control device, comprising:
a computing device;
a storage unit;
a sensor device and/or a communication device; and
wherein the control device is configured for carrying out the method according to claim 1.

19. A motor vehicle, comprising:
a drive unit for providing a drive torque;
a braking device for providing a braking torque;
at least one propulsion wheel being torque-transmittingly coupled to said drive unit and said braking device, and by means of said drive unit and said braking device a propulsion of the motor vehicle is providable on a basis of the drive torque and respectively the braking torque; and
a controller, containing:
a computing device;
a storage unit;
a sensor device and/or a communication device; and
said controller is configured at least for controlling said drive unit in accordance with the method according to claim 1.
